(19) United States
(12) Patent Application Publication
(10) Pub. No.: US 2023/0250251 A1
(43) Pub. Date: Aug. 10, 2023

(54) DISSOLUTION PURIFICATION AND RECOVERY FOR POLYMER RECYCLING

(71) Applicant: Alliance for Sustainable Energy, LLC, Golden, CO (US)

(72) Inventors: Robert David ALLEN, Golden, CO (US); Nicholas A. RORRER, Golden, CO (US); Gregg Tyler BECKHAM, Golden, CO (US); Katrina Marie KNAUER, Denver, CO (US); Minjung LEE, Arvada, CO (US)

(21) Appl. No.: 18/166,331

(22) Filed: Feb. 8, 2023

Related U.S. Application Data
(60) Provisional application No. 63/307,676, filed on Feb. 8, 2022.

(51) Int. Cl. C08J 11/02; C08J 11/08

(52) U.S. Cl. CPC C08J 11/02; C08J 11/08; C08J 2367/02

(57) ABSTRACT

Described herein are systems and methods for the recycling of polymer materials that utilize recoverable solvents to efficiently produce high quality valuable polymer while removing contaminants such as metals, dyes or fibers present in the product to be recycled. The described methods may reduce temperature requirements, both reducing the energy requirements as well as providing higher quality recycled feedstocks by, for example, reducing discoloration due to high temperature processing.

### CROSS-REFERENCE TO RELATED APPLICATIONS

This application claims priority from U.S. Provisional Patent Application No. 63/307,676 filed Feb. 8, 2022, the contents of which are incorporated herein by reference in their entirety.

### CONTRACTUAL ORIGIN

This invention was made with government support under Contract No. DE-AC36-08G028308 awarded by the Department of Energy. The government has certain rights in the invention.

### BACKGROUND

Recycling of high value polymer materials such as aromatic polyesters (including terephthalates) is often economically challenging due to the presence of other materials in the products to be recycled as well as cost and degradation of the resulting polymer feedstock due to mechanical processing and high temperatures. For example, the mechanical recycling of poly(ethylene terephthalate) (PET) requires high temperature (e.g., greater than 250° C.) melting which degrades the color of the recycled product and lowers the molecular weight, reducing the optical and mechanical properties achievable by conventional recycling. While other solvents have been suggested for the recovery of aromatic polyesters, including aniline, dimethylsulfoxide, n-methylpyrrolidone, tetrahydrofuran, triflouroacetic acid and hexaflouroisopropanol, however these all present significant challenges for economic implementation such as high cost, low recovery, degradation, safety concerns. etc.

It can be seen from the foregoing that there remains a need in the art for systems and methods for the recycling of polymers that can be economically implemented while allowing for the removal of impurities or valuable secondary materials in the recyclable materials that allow for high-quality polymer feedstocks to be efficiently recovered.

### SUMMARY

Described herein are systems and methods for the recycling of polymer material that utilize recoverable solvents to efficiently produce high quality valuable polymer while removing contaminants such as metals, dyes, pigments or other foreign matter (e.g., fillers, fibers, etc.) present in the product to be recycled. The described methods may reduce temperature requirements, both reducing the energy requirements as well as providing higher quality recycled feedstocks by, for example, reducing discoloration due to high temperature processing.

The provided systems and method utilize purification of the dissolved material in order to remove the various contaminants while maintaining the physical properties of the polymer material.

In an aspect, provided is a method comprising: a) dissolving at least one polymer in a solvent, thereby generating a dissolved polymer solution; b) purifying the dissolved polymer solution thereby forming a purified dissolved plastic solution; and c) recovering the solvent by treating the purified dissolved polymer solution thereby generating a recovered solvent and a purified recycled polymer.

The provided methods and systems may allow for lower temperature processing to maintain the molecular weight of the initial material or to reduce physical or optical degradation. The step of dissolving the polymer may comprise solvolysis and may be performed at temperatures less than 250° C., 225° C., 200° C., 180° C., 160° C., 150° C. or optionally 140 ° C. The described solvents may also be efficiently recovered, resulting in greater than or equal to 80%, 85%, 90%, 95% or 99% of the initial mass of the solvent being recovered and available for reuse.

Examples of the step of purifying the dissolved polymer solution include filtration, carbon filtration and/or ion exchange.

Examples of the step of recovering the solvent include membrane filtration, evaporation, distillation, spray drying, precipitation and/or devolatilizing extrusion.

The systems and methods described herein may be utilized in a wide variety of polymer materials including aromatic polyesters and other polymers, for example, poly(ethylene terephthalate) (PET), poly(butylene terephthalate) (PBT), unsaturated polyesters, poly(ethylene-terephthalate-co-malate), poly(butylene succinate), poly(butylene adipate-co-terephthalate), polyamides, polycarbonates, amides, phenoxy thermoplastics and other terephthalate polymers. Examples of polyamides include Nylon 6,6, Nylon 6 and Nylon 6,10. The systems and methods may be used to recycle multiple polymers concurrently for materials containing multiple polymers, such as mixed stream recyclables. The systems and methods may also be useful for recycling of textiles, fabrics, garments and the like.

Useful solvents in this application may have low flammability, low toxicity, and high selectivity which will be useful for the recovery of polymers to be used in the food industry.

Solvents that may be useful include guaiacol derivatives, phenolic compounds, lactones, ethers, N-containing cyclic organic compounds, alcohols, acids, ionic liquids and/or beta-gamma unsaturated cyclic sulfones. The solvents may also be switchable polarity solvents. Switchable solvents may include a polarity modifier such as a compressible gas such as CO₂.

Examples of guaiacol derivatives include guaiacol, 4-ethylguaiacol, 4-propylguaiacol, eugenol, isoeugenol.

Examples of phenolic compounds include 4-propyl phenol, thymol, 4-isopropyl phenol, 2-isopropylphenol.

Examples of lactones include gamma valerolactone and caprolactone.

Examples of ethers include cyrene, [(1S,5R)-6,8-dioxabicyclo[3.2.1]-octan-4,4-diol] and cygnet.

Examples of N-containing cyclic organic compounds include pyridine alkaloids, gamma-coinceine, coniine, nicotine, pyrrolidine, pipecolate and piperidine.

Examples of alcohols include benzyl alcohol.

Examples of acids include acetic acid, n-valeric acid, levulinic acid

Examples of ionic liquids include any imidazolium-based ionic liquid as well as 1-Allyl-3-methylimidazolium chloride, 1-butyl-3-methylimidazolium chloride, 1-butyl-2,3 -dimethyl-imidazolium chloride, 1-butyl-3-methylimidazolium acetate, 1-methylimidazole hydrobromide, 1-methylimidazole trifluoromethanesulfonate, 1-methylimidazole bis(trifluoromethanesulfonyl)imide, 1-vinylimidazolium bis(trifluoromethanesulfonyl)imide, 1-allyl-3-methylimidazolium bis(trifluoromethanesulfonyl)imide, 1-butyl-3-methyl-imidazolium bromide, 1-butyl-3-methylimidazolium tetrafluoroborate, 1-butyl-3-methylimidazolium hexafluorophosphate, 1-butyl-3-methylimidazolium trifluoromethanesulfonate, 1-butyl-2,3-dimethylimidazolium hexafluorophosphate, 1-butyl-2,3-dimethylimidazolium tetrafluoroborate, 1-butyl-3-methylimidazolium bis(trifluoromethanesulfonyl)imide, 1-butyl-3-methylimidazolium tetrachloroferrate, 1-butyl-3-methylimidazolium iodide, 1-butyl-2,3-dimethylimidazolium bis(trifluoromethanesulfonyl)imide, 1-butyl-3-methylimidazolium methanesulfonate, 1-butyl-3-methylimidazolium trifluoro(trifluoromethyl)borate, 1-butyl-3-methyl-imidazolium tribromide, 1-butyl-3-methylimidazolium thiocyanate and 1-butyl-2,3-dimethyl-imidazolium triflate.

Examples of beta-gamma unsaturated cyclic sulfones include piperylene sulfone, butadiene sulfone and isoprene sulfone.

Examples of switchable polarity solvents include trialkyl-silylpropylamine, a stoichiometric DBU-alcohol mixture, acyclohexyldimethylamine, and N-ethyl butyl amine.

As described, various other materials may be present in the product that is being recycled. For example, textiles and fabrics may include dyes (including at wt % greater than 5%) or other natural fibers such as cotton and all materials may include high value metal ions, including, Sb, Ge, Ti and Co which may be recovered during the purification of the dissolved polymer solution.

Co-solvents such as acetic acid, phenol and catechol may also be employed in addition to the various solvents described herein. Additionally, a continuous flow system may be used in the step of recovering the solvent to reduce cost and increase efficiency.

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

### Example 1—Dissolution, Purification and Recovery of PET

Post-consumer recycled PET that is used for mechanical recycling (MR) applications represents a substantially pristine feedstock after the various unit operations of sorting and rigorous cleaning to achieve near-zero contamination. Even so, the high temperatures (>250 C) required to melt-process PET flake causes degradation in color (yellowing) and in molecular weight, compromising the mechanical and optical properties of articles made from significant content of MR PET. The goal for this project is to create an improved material, Upgraded Mechanical Recycling PET (UMR-PET) that is amenable to MR without physicochemical degradation of the final products.

PET is used in a wide range of consumer applications making it the second largest used polymer globally. The two primary examples of PET use are textile fibers for clothing and plastics for beverage bottles.

Traditional solvents are largely toxic, halogenated, corrosive, etc. and are not suitable for food-grade application. Here are solvent compositions with a unique set of properties: bio-based for low toxicity (food applications) and low GHG footprint, high selectivity toward polyester polymers, compatibility with purification unit operations, and easy/low energy/near zero waste solvent and polymer recovery.

The described approach includes three steps (DPR):
1. Dissolve the PET flake in a customized and selective solvent composition as described herein.
2. Purify the PET/solvent solution in a series of unit operations, concentrating on foreign polymer and metals removal. Examples include simple filtration, ion exchange or carbon filtration.
3. Recover the solvent and the purified polymer by utilizing a continuous-flow system that allows quantitative removal/recovery of the solvents used in the dissolve step. Examples would be through membrane processing, use of a devolatilizing extruder, spray drying, or precipitation.

Waste polyester contains catalyst residues, other impurities and formulation additives that degrade the thermo-oxidative and mechanical stability of the PET. For this reason, mechanical recycling of recovered PET is limited to high content virgin PET mixtures. Selective dissolution followed by rigorous purification greatly enhances the yield and quality of PET plastic mechanical recycling. For textiles containing high quantity (>5 wt %) of dyes, the DPR process can be exploited to remove/collect the high value dyes and other additives (e.g., cotton) and ultimately may be able to be used to reclaim the polyester. Optionally, the recovered polyester could be catalytically deconstructed with enzymes or other catalysts.

The described invention may be further understood by the following non-limiting examples:

Example 1. A method comprising:
dissolving at least one polymer in an initial mass of a solvent, thereby generating a dissolved polymer solution;
purifying the dissolved polymer solution thereby removing a contaminant, thereby forming a purified dissolved plastic solution; and
recovering the solvent by treating the purified dissolved polymer solution thereby generating a recovered solvent and a purified recycled polymer.

Example 2. The method of example 1, wherein said step of recovering the solvent regenerates a mass of the solvent greater than or equal to 90% the initial mass of the solvent.

Example 3. The method of example 1 or 2, wherein the step of dissolving the at least one polymer in the solvent comprises solvolysis.

Example 4. The method of example 4, wherein the solvolysis is performed at a temperature less than or equal to about 160° C.

Example 5. The method of any of examples 1-4, wherein said step of purifying the dissolved polymer solution comprises filtration, carbon filtration, ion exchange or a combination thereof

Example 6. The method of any of examples 1-5, wherein the step of recovering the solvent comprises membrane filtration, evaporation, distillation, spray drying, precipitation, devolatilizing extrusion or a combination thereof.

Example 7. The method of any of examples 1-6, wherein the step of dissolving comprises a plurality of polymers.

Example 8. The method of any examples 1-7, wherein the at least one polymer comprises poly(ethylene terephthalate) (PET), poly(butylene terephthalate) (PBT), an unsaturated polyester, an aromatic polyester, poly(ethylene-terephthalate-co-malate), poly(butylene succinate), poly(butylene adipate-co-terephthalate), a polyamide, a polycarbonate, an amide, a phenoxy thermoplastic, a terephthalate polymer or a combination thereof.

Example 9. The method of example 8, wherein the at least one polymer comprises a polyamide comprising Nylon 6,6, Nylon 6, Nylon 6,10, or a combination thereof

Example 10. The method of any of examples 1-9, wherein the solvent comprises a lactone, an ether, an N-containing cyclic organic compound, an alcohol, an acid, an ionic liquid, a beta-gamma unsaturated cyclic sulfone or a combination thereof

Example 11. The method of any of examples 1-10, wherein the solvent comprises a lactone selected from the group of: gamma Valero lactone and caprolactone.

Example 12. The method of any of examples 1-11, wherein the solvent comprises an ether selected from the group of cyrene, [(1S,5R)-6,8-dioxabicyclo[3.2.1]- octan-4,4-diol] and cygnet.

Example 13. The method of any of examples 1-12, wherein the solvent comprises an N-containing cyclic organic compound selected from the group of tropane, a pryidine alkaloid, gamma-coniceine, coniine, nicotine, pyrrolidine, pipecolate and piperidine.

Example 14. The method of any of examples 1-13, wherein the solvent comprises an alcohol selected from the group of benzyl alcohol guaiacol, 4-ethylguaiacol, 4-propylguaiacol, eugenol and isoeugenol.

Example 15. The method of any of examples 1-14, wherein the solvent comprises an ionic liquid.

Example 16. The method of example 15, wherein the ionic liquid is an imidazolium-based ionic liquid.

Example 17. The method of example 15, wherein the ionic liquid is selected from the group of 1-Allyl-3-methylimidazolium chloride, 1-butyl-3-methylimidazolium chloride, 1-butyl-2,3-dimethyl-imidazolium chloride, 1-butyl-3-methylimidazolium acetate, 1-methylimidazole hydrobromide, 1-methylimidazole trifluoromethanesulfonate, 1-methylimidazole bis(trifluoromethanesulfonyl)imide, 1-vinylimidazolium bis(trifluoromethanesulfonyl)imide, 1-allyl-3-methylimidazolium bis(trifluoromethanesulfonyl)imide, 1-butyl-3-methyl-imidazolium bromide, 1-butyl-3-methylimidazolium tetrafluoroborate, 1-butyl-3-methylimidazolium hexafluorophosphate, 1-butyl-3 -methylimidazolium trifluoromethanesulfonate, 1-butyl-2,3-dimethylimidazolium hexafluorophosphate, 1-butyl-2,3-dimethylimidazolium tetrafluoroborate, 1-butyl-3-methylimidazolium bis(trifluoromethanesulfonyl)imide, 1-butyl-3-methylimidazolium tetrachloroferrate, 1-butyl-3-methylimidazolium iodide, 1-butyl-2,3-dimethylimidazolium bis(trifluoromethanesulfonyl)imide, 1-butyl-3-methylimidazolium methanesulfonate, 1-butyl-3-methylimidazolium trifluoro(trifluoromethyl)borate, 1-butyl-3-methyl-imidazolium tribromide, 1-butyl-3-methylimidazolium thiocyanate and 1-butyl-2,3-dimethyl-imidazolium triflate.

Example 18. The method of any of examples 1-17, wherein the solvent comprises a beta-gamma unsaturated cyclic sulfone.

Example 19. The method of example 18, wherein the beta-gamma unsaturated cyclic sulfone is selected from the group of piperylene sulfone, butadiene sulfone, isoprene sulfone and a combination thereof

Example 20. The method of any of examples 1-17, wherein the solvent comprises a switchable polarity solvent.

Example 21. The method of example 18, wherein the switchable polarity solvent comprises trialkyl-silylpropylamine, a stoichiometric DBU-alcohol mixture, a cyclohexyldimethylamine, N-ethyl butyl amine, or a combination thereof

Example 22. The method of any of examples 1-21, wherein the contaminants comprise metal ions, dyes, pigments, natural fibers, or a combination thereof

Example 23. The method of example 22, wherein the contaminants comprise metal ions selected from the group of Sb, Ge, Ti, Co or a combination thereof.

Example 24. The method of any of examples 1-23, wherein the step of dissolving the at least one polymer further comprises a co-solvent.

Example 25. The method of example 24, wherein the co-solvent comprises acetic acid, phenol, catechol or a combination thereof

Example 26. The method of any of examples 1-25, wherein the step of recovering the solvent is performed in a continuous flow system.

Example 27. A system for performing the method of any of examples 1-26.

The provided discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. For example, when a device is set forth disclosing a range of materials, device components, and/or device configurations, the description is intended to include specific reference of each combination and/or variation corresponding to the disclosed range.

Every formulation or combination of components described or exemplified herein can be used to practice the invention, unless otherwise stated.

Whenever a range is given in the specification, for example, a density range, a number range, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter is claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method comprising:
dissolving at least one polymer in an initial mass of a solvent, thereby generating a dissolved polymer solution;
purifying the dissolved polymer solution thereby removing a contaminant, thereby forming a purified dissolved plastic solution; and
recovering the solvent by treating the purified dissolved polymer solution thereby generating a recovered solvent and a purified recycled polymer.

2. The method of claim 1, wherein said step of recovering the solvent regenerates a mass of the solvent greater than or equal to 90% the initial mass of the solvent.

3. The method of claim 1, wherein the step of dissolving the at least one polymer in the solvent comprises solvolysis performed at a temperature less than or equal to about 160° C.

4. The method of claim 1, wherein said step of purifying the dissolved polymer solution comprises filtration, carbon filtration, ion exchange or a combination thereof

5. The method of claim 1, wherein the step of recovering the solvent comprises membrane filtration, evaporation, distillation, spray drying, precipitation, devolatilizing extrusion or a combination thereof

6. The method of claim 1, wherein the step of dissolving comprises a plurality of polymers.

7. The method of claim 1, wherein the at least one polymer comprises poly(ethylene terephthalate) (PET), poly(butylene terephthalate) (PBT), an unsaturated polyester, an aromatic polyester, poly(ethylene-terephthalate-co-malate), poly(butylene succinate), poly(butylene adipate-co-terephthalate), a polyamide, a polycarbonate, an amide, a phenoxy thermoplastic, a terephthalate polymer or a combination thereof

8. The method of claim 1, wherein the at least one polymer comprises a polyamide comprising Nylon 6,6, Nylon 6, Nylon 6,10, or a combination thereof.

9. The method of claim 1, wherein the solvent comprises a lactone, an ether, an N-containing cyclic organic compound, an alcohol, an acid, an ionic liquid, a beta-gamma unsaturated cyclic sulfone or a combination thereof.

10. The method of claim 1, wherein the solvent comprises a lactone selected from the group of: gamma Valero lactone and caprolactone.

11. The method of claim 1, wherein the solvent comprises an ether selected from the group of cyrene, [(1S,5R)-6,8-dioxabicyclo[3.2.1]-octan-4,4-diol] and cygnet.

12. The method of claim 1, wherein the solvent comprises an N-containing cyclic organic compound selected from the group of tropane, a pryidine alkaloid, gamma-coniceine, coniine, nicotine, pyrrolidine, pipecolate and piperidine.

13. The method of claim 1, wherein the solvent comprises an alcohol selected from the group of benzyl alcohol guaiacol, 4-ethylguaiacol, 4-propylguaiacol, eugenol and isoeugenol.

14. The method of claim 1, wherein the solvent comprises an ionic liquid; and
wherein the ionic liquid is selected from the group of 1-Allyl-3-methylimidazolium chloride, 1-butyl-3-methylimidazolium chloride, 1-butyl-2,3-dimethyl-imidazolium chloride, 1-butyl-3-methylimidazolium acetate, 1-methylimidazole hydrobromide, 1-methylimidazole trifluoromethanesulfonate, 1-methylimidazole bis(trifluoromethanesulfonyl)imide, 1-vinylimidazolium bis(trifluoromethanesulfonyl)imide, 1-allyl-3-methylimidazolium bis(trifluoromethanesulfonyl)imide, 1-butyl-3-methyl-imidazolium bromide, 1-butyl-3-methylimidazolium tetrafluoroborate, 1-butyl-3-methylimidazolium hexafluorophosphate, 1-butyl-3-methylimidazolium trifluoromethanesulfonate, 1-butyl-2,3-dimethylimidazolium hexafluorophosphate, 1-butyl-2,3-dimethylimidazolium tetrafluoroborate, 1-butyl-3-methylimidazolium bis(trifluoromethanesulfonyl)imide, 1-butyl-3-methylimidazolium tetrachloroferrate, 1-butyl-3-methylimidazolium iodide, 1-butyl-2,3-dimethylimidazolium bis(trifluoromethanesulfonyl)imide, 1-butyl-3-methylimidazolium methanesulfonate, 1-butyl-3-methylimidazolium trifluoro(trifluoromethyl)borate, 1-butyl-3-methyl-imidazolium tribromide, 1-butyl-3-methylimidazolium thiocyanate and 1-butyl-2,3-dimethyl-imidazolium triflate.

15. The method of any claim 1, wherein the solvent comprises a beta-gamma unsaturated cyclic sulfone comprising piperylene sulfone, butadiene sulfone, isoprene sulfone and a combination thereof.

16. The method of claim 1, wherein the solvent comprises a switchable polarity solvent comprising trialkyl-silylpropylamine, a stoichiometric DBU-alcohol mixture, a cyclohexyldimethylamine, N-ethyl butyl amine, or a combination thereof.

17. The method of claim 1, wherein the contaminants comprise metal ions, dyes, pigments, natural fibers, or a combination thereof.

18. The method of claim 17, wherein the contaminants comprise metal ions selected from the group of Sb, Ge, Ti, Co or a combination thereof.

19. The method of claim 1, wherein the step of dissolving the at least one polymer further comprises a co-solvent comprising acetic acid, phenol, catechol or a combination thereof

20. The method of claim 1, wherein the step of recovering the solvent is performed in a continuous flow system.
